(19) United States
(12) Patent Application Publication
(10) Pub. No.: US 2026/0135344 A1
(43) Pub. Date: May 14, 2026

(54) OPTICAL SYSTEM CAPABLE OF ACHIEVING FREQUENCY SWEEPING THROUGH CYCLIC CASCADED STRETCHING

(71) Applicant: Zhejiang Ocean University, Zhoushan (CN)

(72) Inventors: Qingyuan GU, Zhoushan (CN); Huaming WANG, Zhoushan (CN)

(21) Appl. No.: 19/443,012

(22) Filed: Jan. 7, 2026

Related U.S. Application Data
(63) Continuation of application No. PCT/CN2025/132788, filed on Nov. 5, 2025.

(30) Foreign Application Priority Data
Feb. 26, 2025 (CN) 202510214817.7

(51) Int. Cl. H01S 3/067; H01S 3/00

(52) U.S. Cl. CPC H01S 3/06712; H01S 3/0057; H01S 3/06725

(57) ABSTRACT

An optical system capable of achieving frequency sweeping through cyclic cascaded stretching, including an ultrafast pulsed laser, two couplers, a positive-dispersion cyclic stretching module, a negative-dispersion cyclic stretching module, a polarization-maintaining fiber and a delay line. The ultrafast pulsed laser is in communication with the two couplers through the polarization-maintaining fiber. Two ends of the negative-dispersion cyclic stretching module are respectively in communication with the two couplers through the polarization-maintaining fiber. Two ends of the positive-dispersion cyclic stretching module are in communication with the two couplers respectively through the polarization-maintaining fiber and the delay line. The positive-dispersion cyclic stretching module and the negative-dispersion cyclic stretching module are interchangeable in position.

### CROSS-REFERENCE TO RELATED APPLICATIONS

This application is a continuation of International Patent Application No. PCT/CN2025/132788, filed on Nov. 5, 2025, which claims the benefit of priority from Chinese Patent Application No. 202510214817.7, filed on Feb. 26, 2025. The content of the aforementioned application, including any intervening amendments thereto, is incorporated herein by reference in its entirety.

### TECHNICAL FIELD

This application relates to optical technologies, and more particularly to an optical system capable of achieving frequency sweeping through cyclic cascaded stretching.

### BACKGROUND

Frequency-modulated continuous-wave (FMCW) is a radar and lidar technology that performs ranging by using a continuously transmitted frequency-modulated signal. In an FMCW lidar system, a transmitted signal is mixed or undergoes interference with a received signal reflected from a to-be-measured target, and a doppler frequency shift resulting from the mixing or interference is computed and analyzed, thereby enabling accurate measurement of the distance and velocity of the to-be-measured target. Because an FMCW lidar is based on optical coherence technology, it exhibits strong resistance to external interference and has promising application prospects, making it a research direction of considerable potential and significant interest.

The frequency-swept light source is a core component that directly determines the performance of the FMCW lidar system. Existing approaches for implementing frequency sweeping rely on electro-optic modulation using an arbitrary waveform generator as a modulation source, and the achievable sweeping bandwidth is typically difficult to exceed hundreds of gigahertz (GHz). Although some studies have employed multi-segment stitching to extend the range to terahertz (THz), these approaches suffer from slow sweeping speed, frequency hopping at splicing points, and high system costs. In view of this, the present disclosure proposes an optical system for achieving frequency sweeping through cyclic cascaded stretching. The system is based on the characteristic that the spectral dispersion of an ultrafast laser pulse is substantially constant within a target bandwidth. As a result, after an ultrafast laser pulse passes through a dispersive device and is temporally stretched, the spectral components within the bandwidth can be mapped uniformly into the time domain, thereby enabling a sweeping bandwidth up to the THz level.

### SUMMARY

An object of the disclosure is to provide an optical system capable of achieving frequency sweeping through cyclic cascaded stretching to overcome the defects in the prior art. The optical system enables a uniform and monotonic mapping of spectral components into the time domain within the bandwidth, thereby achieving a frequency-sweeping bandwidth up to the terahertz (THz) level.

Technical solutions of the present disclosure are described as follows.

An optical system capable of achieving frequency sweeping through cyclic cascaded stretching, comprising:
an ultrafast pulsed laser;
two couplers;
a positive-dispersion cyclic stretching module;
a negative-dispersion cyclic stretching module;
a polarization-maintaining fiber; and
a delay line;
wherein the ultrafast pulsed laser is in communication with the two couplers through the polarization-maintaining fiber;
a first end of the negative-dispersion cyclic stretching module is in communication with one of the two couplers through the polarization-maintaining fiber, a second end of the negative-dispersion cyclic stretching module is in communication with the other of the two couplers through the polarization-maintaining fiber, a first end of the positive-dispersion cyclic stretching module is in communication with one of the two couplers through the polarization-maintaining fiber, and a second end of the positive-dispersion cyclic stretching module is in communication with the other of the two couplers through the delay line; or the first end of the negative-dispersion cyclic stretching module is in communication with one of the two couplers through the polarization-maintaining fiber, the second end of the negative-dispersion cyclic stretching module is in communication with the other of the two couplers through the delay line, the first end of the positive-dispersion cyclic stretching module is in communication with one of the two couplers through the polarization-maintaining fiber, and a second end of the positive-dispersion cyclic stretching module is in communication with the other of the two couplers through the polarization-maintaining fiber;
the positive-dispersion cyclic stretching module and the negative-dispersion cyclic stretching module each comprises a first optical switch, the two couplers, two erbium-doped fiber amplifiers (EDFAs), a chirped fiber Bragg grating (CFBG), a second optical switch, a third optical switch, a delay fiber, and the polarization-maintaining fiber;
the first optical switch is in communication with one of the two couplers through the polarization-maintaining fiber;
the two EDFAs are respectively in communication with two ends of the CFBG through the polarization-maintaining fiber;
one of the two EDFAs is in communication with one of the two couplers through the polarization-maintaining fiber; and the other of the two EDFAs is in communication with the other of the two couplers through the polarization-maintaining fiber and the delay fiber;
the two couplers are respectively in communication with the second optical switch through the polarization-maintaining fiber; and
one of the two couplers that is arranged between the second optical switch and the delay fiber is in communication with the third optical switch through the polarization-maintaining fiber.

Based on the foregoing technical solutions, the present disclosure may be further modified as follows.

In some embodiments, the CFBG is a positive-dispersion or negative-dispersion CFBG; and the two couplers are each an optical fiber coupler. The CFBG can be customized according to requirements with respect to its dispersion parameters or the temporal width of a single dispersion-induced stretching (e.g., a temporal width of 1.2 nanoseconds for a single dispersion-induced stretching). The EDFAs are configured to compensate for energy losses in each cycle, and the specific energy amplification requirements can be customized or adjusted according to actual needs.

In some embodiments, the ultrafast pulsed laser is configured to emit ultrafast laser pulses having a femtosecond-order or picosecond-order temporal width; and the ultrafast pulsed laser is configured to output a pulsed laser having a pulse width of ≤100 ps.

In some embodiments, the first optical switch, the second optical switch and the third optical switch each have a switching speed at a nanosecond level, a picosecond level or a femtosecond level; and a switching sequence of the first optical switch, the second optical switch and the third optical switch are configured to be controlled by a peripheral circuit or a signal generator.

Compared to the prior art, the present disclosure has the following beneficial effects.

1. The optical system provided herein is based on the characteristic that the dispersion of the spectral components of ultrafast laser pulses is substantially constant within a target bandwidth. As a result, after the ultrafast laser pulses are stretched by a dispersive device, the spectral components within the bandwidth can be mapped uniformly into the time domain, thereby enabling a frequency-sweeping bandwidth up to the terahertz level. This configuration can effectively increase the frequency-sweeping speed, reduce or prevent frequency hopping at splicing points, and reduce the system cost.

2. The optical system provided herein has optical paths entirely connected by polarization-maintaining fibers, where the positive-dispersion cyclic stretching module and the negative-dispersion cyclic stretching module correspond to the use of positive-dispersion CFBG and negative-dispersion CFBG, respectively. Ultrafast laser pulses having a femtosecond-order or picosecond-order temporal width are equally split into two paths by a 50:50 coupler and are directed into the positive-dispersion cyclic stretching module and the negative-dispersion cyclic stretching module, respectively, producing sawtooth-shaped frequency-sweep waveforms having mutually opposite spectral-temporal distributions. By adjusting the temporal offset between the two sawtooth-shaped frequency-sweep waveforms, the optical splicing points can be precisely controlled, and the two optical paths can be recombined via the 50:50 coupler to form a triangular-waveform frequency sweep.

The foregoing description is merely a summary of the technical aspects of the present disclosure. In order to enable a clearer understanding of the technical means of the present disclosure and to allow implementation in accordance with the contents of the specification, the following detailed description is provided with reference to preferred embodiments and the accompanying drawings. The embodiments of the present disclosure are described in detail below with reference to the embodiments and the accompanying drawings.

### BRIEF DESCRIPTION OF THE DRAWINGS

The accompanying drawings described herein are provided to facilitate a further understanding of the present disclosure and form a part of this application. The illustrative embodiments of the disclosure and their descriptions are intended to explain the disclosure and shall not be construed as unduly limiting the scope of the disclosure.

FIG. 1 is a flowchart of an optical system capable of achieving frequency sweeping through cyclic cascaded stretching according to an embodiment of the present disclosure; and

FIG. 2 is a flowchart of a positive-dispersion cyclic stretching module or a negative-dispersion cyclic stretching module in the optical system according to an embodiment of the present disclosure.

### DETAILED DESCRIPTION OF EMBODIMENTS

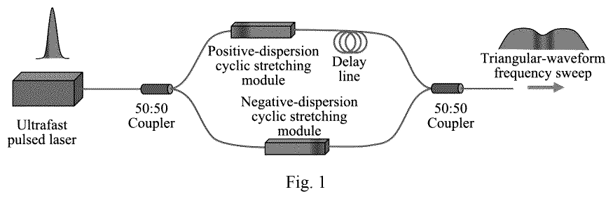

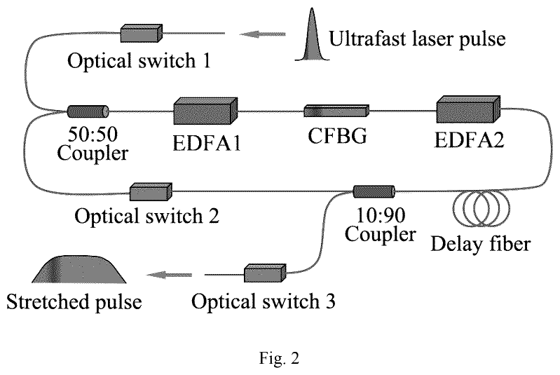

The principles and features of the present disclosure are described below with reference to FIGS. 1-2. The examples provided are intended solely to illustrate the disclosure and are not intended to limit the scope thereof. In the following paragraphs, the disclosure is described in further detail by way of example with reference to the accompanying drawings. The advantages and features of the disclosure will become apparent from the following description and the claims. It should be noted that the accompanying drawings are presented in a highly simplified form and are not drawn to scale, and are provided solely for the purpose of facilitating and clarifying the description of the embodiments of the present disclosure.

It should be noted that when a component is referred to as being “fixed to” another component, it may be directly on the other component or may also include one or more intermediate components. When a component is described as being “connected to” another component, it may be directly connected to the other component or may involve one or more intermediate components. When a component is described as being “provided on” another component, it may be directly provided on the other component or may include one or more intermediate components. The terms “vertical”, “horizontal”, “left” and “right” used herein are provided solely for illustrative purposes.

Unless otherwise defined, all technical and scientific terms used herein have the same meanings as commonly understood by those of ordinary skill in the art to which the present disclosure belongs. The terminology used in the specification of the present disclosure is for the purpose of describing embodiments only, and is not intended to limit the scope of the disclosure. The term “and/or” as used herein includes any and all combinations of one or more of the associated listed items.

As shown in FIGS. 1-2, an embodiment of the present disclosure provides an optical system capable of achieving frequency sweeping through cyclic cascaded stretching, including an ultrafast pulsed laser, two couplers, a positive-dispersion cyclic stretching module, a negative-dispersion cyclic stretching module, a polarization-maintaining fiber and a delay line. The ultrafast pulsed laser is in communication with the two couplers through the polarization-maintaining fiber. A first end of the negative-dispersion cyclic stretching module is in communication with one of the two couplers through the polarization-maintaining fiber, a second end of the negative-dispersion cyclic stretching module is in communication with the other of the two couplers through the polarization-maintaining fiber, a first end of the positive-dispersion cyclic stretching module is in communication with one of the two couplers through the polarization-maintaining fiber, and a second end of the positive-dispersion cyclic stretching module is in communication with the other of the two couplers through the delay line; or the first end of the negative-dispersion cyclic stretching module is in communication with one of the two couplers through the polarization-maintaining fiber, the second end of the negative-dispersion cyclic stretching module is in communication with the other of the two couplers through the delay line, the first end of the positive-dispersion cyclic stretching module is in communication with one of the two couplers through the polarization-maintaining fiber, and a second end of the positive-dispersion cyclic stretching module is in communication with the other of the two couplers through the polarization-maintaining fiber.

The positive-dispersion cyclic stretching module and the negative-dispersion cyclic stretching module each includes a first optical switch 1, the two couplers, two erbium-doped fiber amplifiers (EDFAs), a chirped fiber Bragg grating (CFBG), a second optical switch 2, a third optical switch 3, a delay fiber, and the polarization-maintaining fiber. The first optical switch 1 is in communication with one of the two couplers through the polarization-maintaining fiber. The two EDFAs are respectively in communication with two ends of the CFBG through the polarization-maintaining fiber. One of the two EDFAs is in communication with one of the two couplers through the polarization-maintaining fiber. The other of the two EDFAs is in communication with the other of the two couplers through the polarization-maintaining fiber and the delay fiber. The two couplers are respectively in communication with the second optical switch 2 through the polarization-maintaining fiber. One of the two couplers that is arranged between the second optical switch 2 and the delay fiber is in communication with the third optical switch 3 through the polarization-maintaining fiber.

In some embodiments, the CFBG is a positive-dispersion or negative-dispersion CFBG; and the two couplers and the two couplers are each an optical fiber coupler.

In some embodiments, the ultrafast pulsed laser is configured to emit ultrafast laser pulses having a femtosecond-order or picosecond-order temporal width. The ultrafast pulsed laser is configured to output a pulsed laser having a pulse width of ≤100 ps.

In some embodiments, the first optical switch, the second optical switch and the third optical switch each have a switching speed at a nanosecond level, a picosecond level or a femtosecond level; and a switching sequence of the first optical switch, the second optical switch and the third optical switch is configured to be controlled by a peripheral circuit or a signal generator.

The specific operating principle and method of use of the present disclosure are as follows.

In the optical system shown in FIG. 2, the optical paths are interconnected by polarization-maintaining optical fibers. The ultrafast laser pulses have a femtosecond-order or picosecond-order temporal width, and is introduced into a ring cavity through a 50:50 coupler. The CFBG may be customized as required with respect to its dispersion parameters or the temporal width of a single dispersion-induced stretching. The EDFA is configured to compensate for the energy loss incurred during each circulation, and the specific amplification requirement may be customized or adjusted according to actual needs. A switching sequence of the three optical switches with nanosecond-level (or faster) response times are strictly controlled by peripheral circuits or signal generators to coordinate the overall system switching timing and the number of circulations of the light within the loop cavity. The number of circulations is jointly determined by the length of the ring cavity and the temporal width of the CFBG-induced single dispersion stretching (for example, 1.2 ns). The length of the delay fiber is selected to match the temporal width of the stretched pulse to be achieved. The optical energy output from the optical switch 3 is split by a 10:90 coupler (or another ratio, such as 20:80), such that 90% (or another proportion, such as 80%) of the optical energy is directed to circulate within the ring cavity, while the remaining 10% of the optical energy is output from the ring cavity via the third optical switch 3. It should be understood that the 10:90 coupling ratio is provided merely by way of example, and other coupling ratios may be adopted according to practical requirements, such as 20:80, 30:70, 50:50, or other suitable ratios. The system is capable of achieving a sawtooth-shaped frequency-sweep waveform from the nanosecond to the microsecond range.

In the optical system shown in FIG. 1, all optical paths are interconnected by polarization-maintaining fibers. The positive-dispersion cyclic stretching module and the negative-dispersion cyclic stretching module correspond to the optical module illustrated in FIG. 2, in which positive-dispersion CFBG and negative-dispersion CFBG are employed, respectively. Ultrafast laser pulses having a femtosecond-order or picosecond-order temporal width are equally split into two paths by a 50:50 coupler, and are directed into the positive-dispersion cyclic stretching module and the negative-dispersion cyclic stretching module, respectively, which output sawtooth-shaped frequency-sweep waveforms having mutually opposite spectral-temporal distributions. The delay line is a polarization-maintaining delay fiber whose length corresponds to a product of the temporal width of the stretched pulses output from the optical system of FIG. 1 and a propagation speed of light in the fiber. The delay line is configured to precisely control the temporal offset between the two sawtooth-shaped frequency-sweep waveforms, thereby enabling accurate control of the splicing points between the two optical paths. The two optical paths are then recombined by a 50:50 coupler to form a triangular-waveform frequency sweep.

It should be noted that, as used herein, relational terms such as “first” and are employed solely to distinguish one entity or operation from another, and do not necessarily require or imply any actual relationship or order between such entities or operations. Any subject matter not described in detail in the present specification is deemed to fall within the scope of the prior art known to those of ordinary skill in the relevant field.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An optical system capable of achieving frequency sweeping through cyclic cascaded stretching, comprising:
an ultrafast pulsed laser;
two couplers;
a positive-dispersion cyclic stretching module;
a negative-dispersion cyclic stretching module;
a polarization-maintaining fiber; and
a delay line;
wherein the ultrafast pulsed laser is in communication with the two couplers through the polarization-maintaining fiber;
a first end of the negative-dispersion cyclic stretching module is in communication with one of the two couplers through the polarization-maintaining fiber, a second end of the negative-dispersion cyclic stretching module is in communication with the other of the two couplers through the polarization-maintaining fiber, a first end of the positive-dispersion cyclic stretching module is in communication with one of the two couplers through the polarization-maintaining fiber, and a second end of the positive-dispersion cyclic stretching module is in communication with the other of the two couplers through the delay line; or the first end of the negative-dispersion cyclic stretching module is in communication with one of the two couplers through the polarization-maintaining fiber, the second end of the negative-dispersion cyclic stretching module is in communication with the other of the two couplers through the delay line, the first end of the positive-dispersion cyclic stretching module is in communication with one of the two couplers through the polarization-maintaining fiber, and a second end of the positive-dispersion cyclic stretching module is in communication with the other of the two couplers through the polarization-maintaining fiber;
the positive-dispersion cyclic stretching module and the negative-dispersion cyclic stretching module each comprises a first optical switch, the two couplers, two erbium-doped fiber amplifiers (EDFAs), a chirped fiber Bragg grating (CFBG), a second optical switch, a third optical switch, a delay fiber as the delay line and the polarization-maintaining fiber;
the first optical switch is in communication with one of the two couplers through the polarization-maintaining fiber;
the two EDFAs are respectively in communication with two ends of the CFBG through the polarization-maintaining fiber;
one of the two EDFAs is in communication with one of the two couplers through the polarization-maintaining fiber; and the other of the two EDFAs is in communication with the other of the two couplers through the polarization-maintaining fiber and the delay fiber;
the two couplers are respectively in communication with the second optical switch through the polarization-maintaining fiber; and
one of the two couplers that is arranged between the second optical switch and the delay fiber is in communication with the third optical switch through the polarization-maintaining fiber.

2. The optical system of claim 1, wherein the CFBG is a positive-dispersion or negative-dispersion CFBG; and the two couplers are each an optical fiber coupler.

3. The optical system of claim 1, wherein the ultrafast pulsed laser is configured to emit ultrafast laser pulses having a femtosecond-order or picosecond-order temporal width; and the ultrafast pulsed laser is configured to output a pulsed laser having a pulse width of ≤100 ps.

4. The optical system of claim 1, wherein the first optical switch, the second optical switch and the third optical switch each have a switching speed at a nanosecond level, a picosecond level or a femtosecond level; and a switching sequence of the first optical switch, the second optical switch and the third optical switch is configured to be controlled by a peripheral circuit or a signal generator.
